(19) United States
(12) Patent Application Publication
(10) Pub. No.: US 2009/0298036 A1
(43) Pub. Date: Dec. 3, 2009

(54) Replacing Physical Publication Appendices With Enhanced Electronic Versions

(75) Inventor: Aaron J. Greenspan, Palo Alto, CA (US)

Correspondence Address: COURTNEY STANIFORD & GREGORY LLP, 10001 N. De Anza Blvd., Suite 300, Cupertino, CA, 95014, US

(73) Assignee: THINK COMPUTER CORPORATION, Palo Alto, CA (US)

(21) Appl. No.: 12/477,106

(22) Filed: Jun. 2, 2009

Related U.S. Application Data
(60) Provisional application No. 61/057,949, filed on Jun. 2, 2008.

(51) Int. Cl. G09B 5/00; G06F 17/00; G06F 17/30

(52) U.S. Cl. 434/317; 715/207; 707/10; 715/205; 707/E17.032; 707/E17.045

(57) ABSTRACT

Embodiments are directed to a system that allows publishers to publish bibliographic data, reference data, and/or author notes of non-fiction materials (e.g. books, journals, etc.) on an Internet web site with a formal structure rather than in paper form. Bibliographic references and author notes are stored in a computer database, and presented to end users through web pages in such a manner that references can be displayed alongside digital images of the physical pages that they originated from, with hypertext links to digital files representing the author's original sources, as appropriate. A method comprises providing a printed component of a book including a page containing a reference to a network site providing access to an electronic component of the book, displaying at least a portion of the electronic component of the book upon user access to the network site, wherein the display includes a portion of the text of the book and one or more links available in that portion, and requesting authentication of the user to provide evidence of authorized use of the book.

### CROSS-REFERENCE TO RELATED APPLICATIONS

The present application claims the benefit of the U.S. Provisional Application No. 61/057,949 entitled “A Method to Replace Physical Publication Appendices with Corresponding and Enhanced Electronic Versions,” and filed on Jun. 2, 2008.

### FIELD

Embodiments of the invention relate generally to electronic book and document systems, and more specifically, to implementation of bibliographic information on the Internet to supplement a printed book.

### BACKGROUND

Many printed non-fiction books contain supplemental sections for bibliographic information and notes that support claims made by the author or provide additional material for the work. Such sections may be provided in the form of endnotes, appendices, exhibits, supplemental notes, bibliographies, and the like. These sections can often span several hundred pages, and may be of interest to only a small percentage of consumers. However, when consumers use these sections for reference purposes, they tend to use them heavily. Therefore, they can represent an important resource for a particular work, and eliminating them entirely is not a viable option.

Through the globally interconnected computers of the World Wide Web (“web”), the Internet provides an effective mechanism by which textual information printed in books can be distributed to a wide audience. Yet for a variety of reasons that are both technical and business-related in nature, most consumers still prefer to read books in paper form, and not over the Internet. Nonetheless, it is possible to represent a book in digital form and present it as HTML markup in the form of a web page.

The advent of the electronic book (“e-book”) has attempted to transform traditional paper-based books into electronic form that may be read through computers or specialized e-book readers. In this form, virtually any printed publication, once converted, can be stored on an appropriate medium (e.g., magnetic disk, optical disk, flash memory, etc.) and read through a suitably configured processing device, such as a computer, e-book reader, kiosk, smart phone, and so on. Like other forms of electronic publishing, e-books have yet to gain widespread acceptance, due to factors such as digital rights management restrictions, reliance on hardware devices, and traditional preferences for paper-based books.

Certain publications or types of publications, however, lend themselves toward implementation in electronic format as opposed to printed publication. These include reference, supplemental, or bibliographic sections that may be voluminous, but that may not form the body of the actual book or publication. Such sections may benefit from the compression and portability provided by implementation in electronic format. Such sections may also benefit from electronic linking technology provided by hyperlink and similar mechanisms provided by certain Internet technologies.

Present paper-based publications obviously do not provide means for dynamic linking of material within other works, rather than simply providing a reference through which the user must find and acquire or look up the material separately. Likewise, present e-book or electronic publication systems typically provide an entire body of work in electronic form without regard to the nature of the work or any particular section of the work.

What is desired is an electronic publication system that distributes the information typically contained in supplemental bibliographic sections through electronic means, such as through the Internet, instead of on the printed page.

What is further desired is a system that reduces the cost of book printing by using the World Wide Web to distribute certain portions of a publication in order to reduce the total amount of a book that is distributed in paper form.

### SUMMARY OF EMBODIMENTS

Embodiments of the present invention allow publishers to publish bibliographic data, reference data, and/or author notes of non-fiction materials (e.g. books, journals, etc.) in electronic form, such as on an Internet web site, with a formal structure rather than in paper form. Bibliographic references and author notes are stored in a computer database, and presented to end users through web pages in such a manner that references can be displayed alongside digital images of the physical pages that they originated from, with hypertext links to digital files representing the author's original sources, as appropriate. In this manner, a printed publication can be presented electronically in a web page along with one or more links that may be present in the pages of the publication. Clicking on a link allows the user to access the supplemental or reference content from a database that stores this supplemental content.

For any given page of a printed work, end users can also comment on that page specifically or on the work as a whole by sending textual data through a web page. End users can identify publications that make use of the present invention by seeking a unique graphical trademark on the back of a book jacket or within a printed publication, which symbolizes that the work makes use of the present invention's enhanced technology. To protect the publisher's business interests, the web site may be designed to be accessible to only those individuals who have purchased a copy of the literary work in question.

Embodiments effectively allow publishers of non-fiction materials to place supplemental information on a global network in a standardized format instead of in print, thereby eliminating the need for certain raw materials. Certain advantages associated with electronic storage and distribution can then be exploited for the information typically contained in supplemental bibliographic sections. For example, each textual reference can be linked to the digital representation of the source that it symbolizes, whether that source is a document, web page, video, audio recording, or digital file representing information in some other medium. When broken down by page and displayed side-by-side with a digital graphical representation of the relevant page in the book, bibliographic references can therefore be made much more useful thanks to the inherent ability of HTML to link text to other web sites.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a block diagram of a computer network system that implements embodiments of an electronic publication system for an enhanced book, according to an embodiment.

FIG. 2 is a flowchart of a method of utilizing an electronic publication system, according to an embodiment.

FIG. 3 is a view of a printed page of the physical component of an enhanced book showing access to the associated electronic component, under an embodiment.

FIG. 4 is a view of an example web page or digital electronic book reader interface representing a digital embodiment of the electronic component of an enhanced book, according to an embodiment.

FIG. 5 is a view of an example web page or digital electronic book reader interface that serves as an authentication mechanism for the user, under an embodiment.

FIG. 6 is a view of an example web page or digital electronic book reader interface that lists supplemental content and bibliographic sources associated with an enhanced book, under an embodiment.

### DETAILED DESCRIPTION

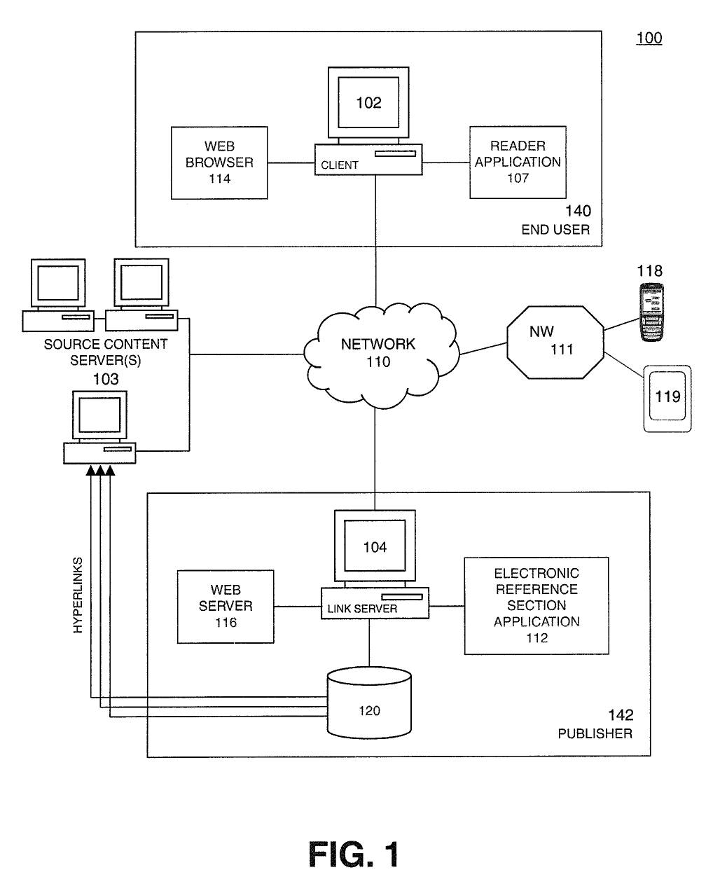

Embodiments of an electronic publication system are described. Aspects of the one or more embodiments described herein may be implemented on one or more computers executing software instructions. The computers may be networked in a client-server arrangement or similar distributed computer network. FIG. 1 illustrates a computer network system 100 that implements one or more embodiments. In system 100, a network server computer 104 is coupled, directly or indirectly, to one or more network client computers 102 through a network 110. The network interface between server computer 104 and client computer 102 may include one or more routers (not shown) that serve to buffer and route the data transmitted between the server and client computers. Network 110 may be the Internet, a Wide Area Network (WAN), a Local Area Network (LAN), or any combination thereof.

In one embodiment, the server computer 104 is a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computer 104 and any available content provider or supplemental server, such as a publisher's server 103. For an embodiment in which network 110 is the Internet, network server 104 executes a web server process 116 to provide HTML documents, typically in the form of web pages, to client computers 102 coupled to the network. To access the HTML files provided by server 104, client computer 102 executes a web browser process 114 that accesses web pages available on server 104 and other Internet server sites, such as content provider 103 (which may also be a network server executing a web server process). The client computer 102 may access the Internet 110 through an Internet Service Provider (ISP).

For the system shown in FIG. 1, server 104 is a server that executes a server-side electronic reference section process 112. Server 104 may be maintained, licensed, operated or otherwise controlled by or on behalf of a publisher 142. In general, a publisher is an entity that produces or makes available books or other publications that are available in printed (paper) form. The electronic reference section application 112 facilitates the incorporation of electronic content with the paper books to create a book referred to as an “enhanced book” that comprises a printed component and an electronic component.

The client computer or computers 102 are operated by end users (readers) 140 who purchase (or otherwise acquire) and read the enhanced books. The users may read the actual book using the printed component of the book, and access the electronic component over network 110 to read the electronic component through the web browser 114. Depending upon the network architecture and client computer configuration, client versions of the electronic reference section application 107 may also be executed on the client computers. The client computer 102 may be a workstation computer or it may be a computing device such as a notebook computer, personal digital assistant (PDA), or the like. The client computer may also be embodied within a mobile communication device, smartphone, or similar computing device that provides access to the Internet network 110 and a sufficient degree of user input and processing capability to access server 104 or execute a client-side reader program 107. The client computer may also be embodied in an electronic book reader, console, or similar media playback unit 119 that has network access through cell or similar transmission means. Thus, the client computers may be coupled to the server computer 104 over a wired connection or wireless connection through an additional network 111, such as a cellular telephone network.

Process 112 may represent one or more executable programs modules that are stored within network server 104 and executed locally within the server. Alternatively, however, it may be stored on a remote storage or processing device coupled to server 104 or network 110 and accessed by server 104 to be locally executed. In a further alternative embodiment, the electronic reference section process 112 may be implemented in a plurality of different program modules, each of which may be executed by two or more distributed server computers coupled to each other, or to network 110 separately.

In one embodiment, the enhanced book comprises a printed component that consists of the printed book itself. This printed component may also be provided in electronic form by the publisher 142. The printed component references one or more items of bibliographic or supplemental (reference) material, which the publisher may provide in purely electronic form. The printed component has a number of links that provide access to this reference material. The links for an enhanced book are stored in a database within data store 120 which is coupled (closely or remotely) to server 104. Server 104 acts as a link server through process 112 which serves the reference links that are available in the printed component of the book to the user. The actual reference content is stored in one or more databases maintained by source content server(s) 103. These content servers thus provide the content for the links that are served by process 112. For example, an enhanced book may contain a bibliographic link to a source newspaper article. In this case, the link is stored in data store 120 and the server 104, through process 112 serves the link as part of the enhanced book. The actual newspaper article may be stored in a server 103 maintained by the newspaper publisher. Content server(s) 103 may be maintained by any entity that provides at least some of the data that is included in the electronic portion of the enhanced book, and may include other publishers, news sites, other users, and so on.

Embodiments of the electronic reference section process allow a publisher to make available to a user a portion of a physical book in electronic format. A publisher of a given book might wish to provide this capability in order to reduce the materials, printing and shipping costs associated with manufacturing the book by replacing paper bibliographies, large note sections and appendices with electronic versions of the same available on the Internet as HTML markup only to purchasers of the book. For the embodiment of FIG. 1, a content providers 103 store supplemental material for association with the enhanced books provided in both printed and electronic form by the publisher 142. The electronic reference section application 112 allows access to the content providers 103 and provides a platform for the linking of printed publications and the online reference sections. In certain cases, the publisher 142 may store the content referenced by a link in a data store (e.g., data store 120) directly accessed by the server 104.

According to embodiments, a book or printed publication available through the system of FIG. 1 would have two main parts: a print component and an electronic component available through the network 110. Embodiments are designed to be used in conjunction with trade books, reference books, or academic books, which are typically available in bound form (e.g., hardcover, paperback, pamphlet form) and offered for sale at retail establishments. Embodiments can also be used in conjunction with or other fiction or non-fiction publications such as journals, magazine articles, and novels. In general, any publication that requires or has associated with it a significant amount of background knowledge, specialized terminology, or associated material is suitable for use in the present system. For the purposes of this description, the word “book” shall refer to all of the above, as well as any printed publication that may have or benefit from having one or more sections that can be provided in electronic format. Also for purposes of this description, the terms bibliographic, supplemental, or reference are used interchangeably to refer to any material that is additional to the body of a physical printed book or document, and that a publisher may want to provide in electronic format over a network. In general, the term print component refers to the book, and the term electronic component refers to the supplemental material that is provided electronically over the network. Together, these form an enhanced book that is provided by publisher 142 to end user 140 over network 110, as shown in FIG. 1.

The electronic component of the book is designed to provide readers with the same content that would normally be found in a book's bibliography, appendices, or reference sections. That is, citations to external sources and/or notes by the author concerning the book's contents. Due to the flexibility and capabilities of the World Wide Web, the electronic reference section process also allows the addition by authors or publishers of relevant hyperlinks, primary source documents, comments from readers, and the categorization of page content and the aforementioned links of various types.

In one embodiment, a book that has an electronic component is marked with appropriate legends or trademark to indicate that such an electronic component is available. These books may be specially marketed and referred to as a specific type of enhanced book, such as an Interbook®.

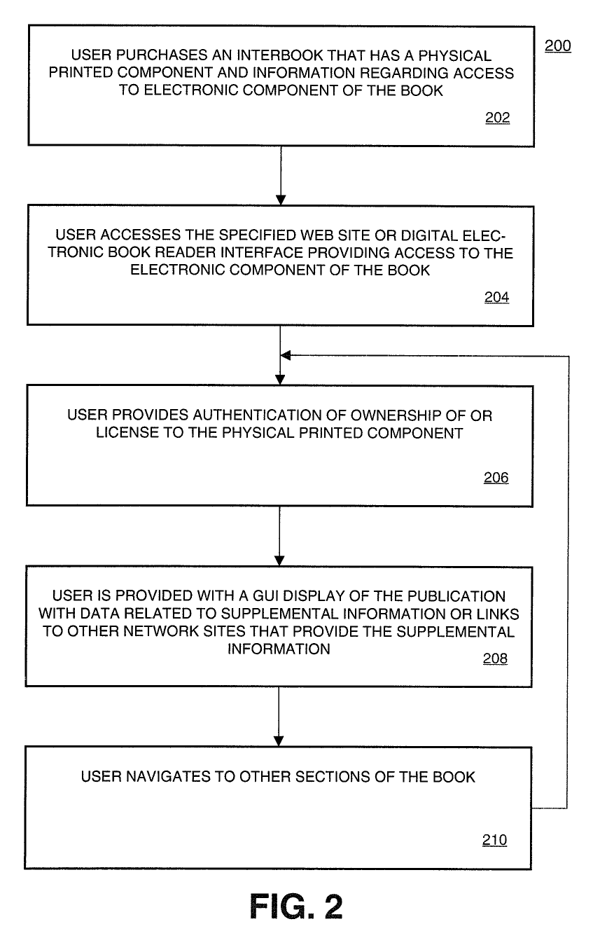

FIG. 2 is a flowchart of a method of utilizing an electronic publication system according to an embodiment. In block 202, the user purchases or otherwise acquires an enhanced book that has an electronic component. In one embodiment, the print component may comprise the actual printed book itself, and also has a page or section that tells users who might wish to purchase the book that it makes use of the electronic reference section application 112 to provide an electronic component. A book publisher wishing to use this system may include a page in its printed book stating, in conjunction with a graphical trademark, that the book makes use of the technologies described herein. This notice may further provide a network address (e.g., a web address) that the user 140 can access on his or her Internet-connected client computer 102 to view and make use of the electronic component of the present invention. The publisher 142 can include the same trademark anywhere on the publication cover (such as on the book jacket's back cover or on the book's spine) so that potential users may readily identify the book with the electronic reference section application.

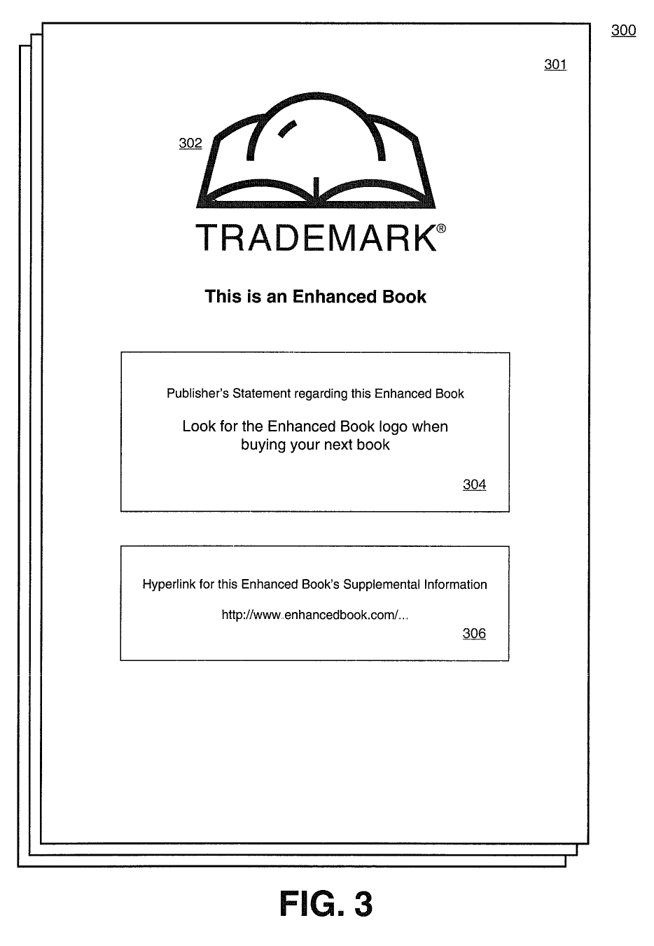

FIG. 3 is a view of a printed page of the physical component of a book showing access to the associated electronic component of a book, under an embodiment. Book 300 has a number of pages, of which page 301 indicates that the book as an enhanced book that provides access to an electronic component. Access page 301 may be provided in any appropriate location of the book, and is typically just before or after the book's title page. Page 301 includes a logo and/or other trademark or legend 302 that shows the user that the book has an electronic component that is available through an electronic reference section application 112. Access page 301 may also include several other text and graphic sections, such as a publisher's statement regarding the book and any marketing or promotional messages 304. This page also includes the web address of the electronic component of the book 306. In an embodiment, the web site referenced by the address contains an electronic version of the book as well as the reference links within the book. These links provide access to the actual reference content that may be available by other content providers 103.

As shown in FIG. 2, in block 204, the user accesses the web site 306 specified in the access page 301 of the physical book 300. Upon accessing this web site, the reader is presented with a web page containing the same book's title, subtitle, author and optionally a digital image of the book's cover, along with a main section of the web page offering the options of reading the book or viewing all of the book's links. Other options may include purchasing the book, if the book has not yet been purchased. This option is available in cases where the electronic component of the book is readily accessible to all users on the Internet, and may be found through a web search or direct access to the web link.

If the user does not purchase the book, but instead elects to read the book or access the book's links, the user may be required to authenticate ownership of the book or authorized use before use of the electronic component, block 206. Initial authentication of the book may be provided through any number of authentication mechanisms, such as providing a product number, bar code number, password or similar code that may be provided in the book or book's packaging.

If the user elects to read the book, the system brings the reader to a page with a digital graphic representation of the first page in the book, combined with navigation controls to move forward or back one page as appropriate, a search field to locate specific text-based strings in the book, and/or other options as appropriate, block 208. To whichever side of the image of the printed page the publisher deems appropriate, a list of links relevant to that page are listed. These links may include, but are not limited to, bibliographic references, primary sources, relevant web sites, embedded text, graphic or audio files, links to other pages in the same publication, and so on. On the same Web page comments from readers concerning the given book can also be presented if the reader has proven ownership of the book.

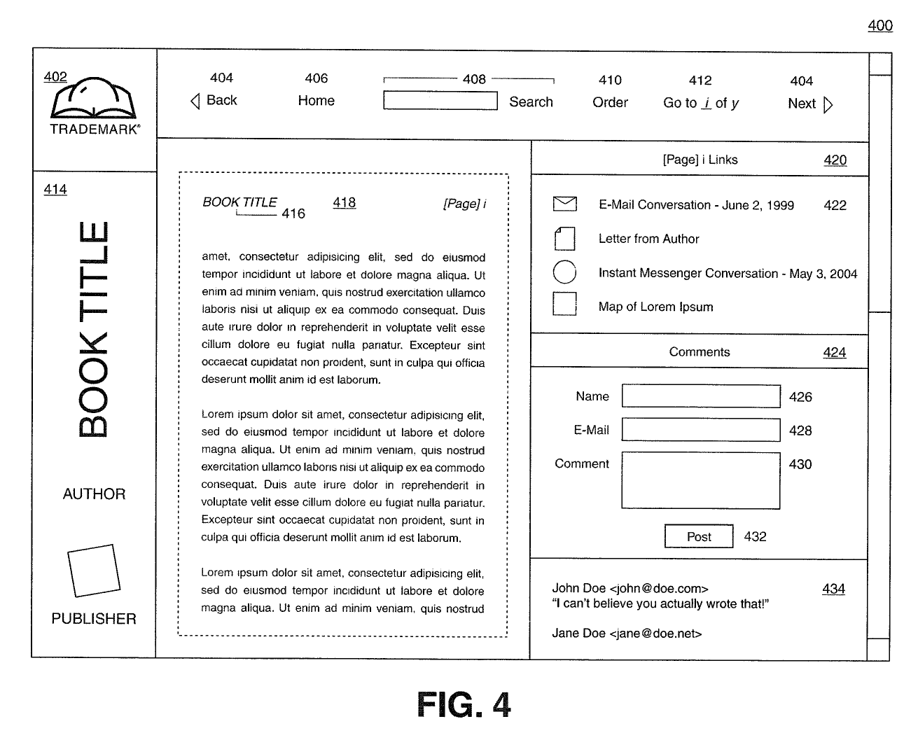

FIG. 4 is a view of a web page or electronic book reader interface representing a digital embodiment of the electronic component of a book, according to an embodiment. Web page 400 includes a number display areas and elements that may be arranged and presented in many different ways. The appropriate trademark 402 that identifies the book as an enhanced book and associates it with the print copy is provided on the page 400, as are navigation hyperlinks 404 to go back or forward one page through the electronic book. Other navigation buttons include a “go to” button 412 to jump directly to a specific page of the total number of pages in the book being read, and a home button 406 that navigates the user to the server 104 home page, or the publisher's 103 home page. The system may also include an input field 408 for a search feature that allows the user to search for and find specific words, phrases or text strings. As stated above, in certain cases, the physical book may be purchased through the publisher's web site. In this case, an “order” button 410 may be provided to allow the user to order a physical or electronic copy of the book being read.

In one embodiment, a legend section 414 of web page 400 includes the book title 416, subtitle, author, publisher, and any other relevant information. The legend section 414 may be a digital representation or facsimile of the actual spine of the physical book. Display section 418 provides a digital graphical representation of a page in the book being read. The book title 414 is constantly displayed in this section, along with the page number of the displayed page. The links for the displayed page are provided in display area 420. Links may be classified into different types, depending on the linked content. The linked supplemental content typically comprises text data that has been generated by a specific application, and that may be stored in an appropriate format. The linked content may thus be text, graphics, other links, applets, or any content that is capable of being associated with or incorporated into the displayed page 418 using appropriate web-based technology. Linked text content may be generated from any number of sources, such as word processor documents, scanned (.pdf) documents, e-mail messages, and the like. The example of FIG. 4 illustrates three different links 422 along with associated icons depicting link categorization based on the type of file or source application. Example links 422 include a text of an e-mail conversation, a letter from the author in scanned form, and an instant messenger (IM) conversation.

The links themselves are typically stored in a database (e.g., data store 120) maintained by publisher 142, and the content accessed by the links is typically stored and provided by one or more other content providers 103. The links in display area 420 may be all of the links associated with a particular page of the book shown in display area 418, or for a chapter of the book or any other defined portion. If a page has no links, the message “no links for this page” may be displayed in display area 420. The links for a page may be referenced by numeric codes, such as in the format of footnotes, within the text shown in display area 418, or they may simply be listed, as shown in the example of FIG. 4

As shown in FIG. 4, each textual reference is linked to the digital representation of the source that it symbolizes. The source may be a document, web page, video, audio recording, or digital file representing information in some other medium. These links are broken down by page and displayed side-by-side with a digital graphical representation of the relevant page in the book. The links are HTML web links to one or more other web sites. In this manner, bibliographic references or other supplemental information is made readily available in its source form thanks to the inherent ability of HTML to link text to other web sites.

As a user reads the printed component of the book, he or she can scroll through the pages online at the same time, or otherwise jump to specific pages of the electronic version of the book to access links within each page. The user can then access the supplemental material provided by the links through the HTML mechanism provided in the electronic component. In this manner, supplemental information related to the text of the book can be efficiently provided to the user without requiring its physical incorporation in the actual book. For example, a book referencing a university can include hyperlinks to pictures of the campus that the user can view through over the web without requiring the publisher to include the photographs in the printed book. This greatly enhances the content of the book and the user experience without requiring the publisher to incorporate all of this additional material in the book. The user can also pick and choose very easily which supplemental material to view without needing to sift through all of the supplemental material that might be available in a book. This mechanism also helps to minimize rights management issues since the source material is accessed from the content provider or original source directly.

In one embodiment, the web page 400 may also include a display area for user comments 424. Comments may be provided by the user regarding the content of the displayed page 418 or any of the linked content 422. The comment section includes a field 426 to store a reader's name who wishes to leave a comment, a field 428 to store a the e-mail address of the reader who wishes to leave a comment, and a comment field 430 to store the reader's comment. A submit or post button 432 transmits the reader's comment to the server 104 and allows it to be associated with the displayed page 418. Saved comments can be displayed in a separate display area 434. Comments can be provided for any specific page specifically or on the work as a whole through textual data input through the web page 400 using appropriate function calls, such as an HTTP POST, GET, or other Internet request.

The layout and composition of the web page of FIG. 4 is intended to be an example of one arrangement, and many other arrangements are possible. For example, any of the main display areas 418, 420 or 424 may be provided on a separate web page in order to maximize the amount of screen space provided to the displayed page, link content, or reader comments.

The web page display 400 generally changes with respect to the links and comments as the user navigates through different pages 418 of the book, block 210. In one embodiment, the publisher may require authentication past a specific page, chapter, or section in any given book, at which point the normal flow of reading by clicking through pages or navigation links is interrupted and a web page is displayed requesting the information. With reference to FIG. 2, user authentication may be provided in block 206. Ownership of the book can be proven by asking the reader to input, using a computer keyboard, mouse, voice recognition software, and/or other computer input device, a specific word on a specific page of the book that would not be obvious to anyone without physical possession of the book or the ability to readily access the electronic component of the book. In one embodiment, the specific word requested is automatically determined by selecting a random number between 1 and 20 on a page number between the number representing the first page the publisher has determined should not be freely accessible to the public and the number representing the last page of the book, and ultimately storing the corresponding word in memory. The message asking the reader to input the correct word links to a web site allowing the reader to purchase a physical copy of the book in the event that the reader does not already have a copy, so that he or she may continue to navigate through the book. Upon successfully matching the word provided by the reader and the word contained within the present invention's database of book content, the reader is allowed to continue reading as before, with access to all of the book's links and all reader comments, block 208.

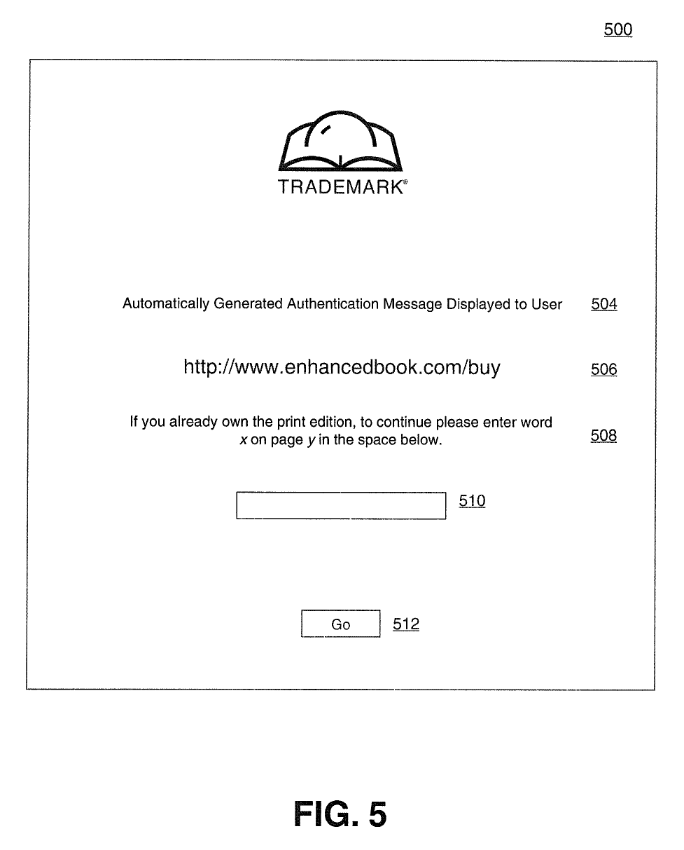

FIG. 5 is a view of an example web page that serves as an authentication mechanism, under an embodiment. This page is used to ensure that only those individuals who have purchased a given publication can access the linked sources for that publication past a certain page in the publication. As shown in FIG. 5, web page 500 includes the logo denoting that the book is of the specific type that allows access to an electronic component. The display area displays an automatically-generated authentication message 504 that states the publisher's statements regarding authentication. If the user needs to order the book, an HTTP (hypertext transport protocol) link 506 is provided to allow access to a web page where a physical or electronic copy of the book can be purchased. The explanatory message for the authentication process 508 is then displayed, along with an input field 510 for the authentication token. The token is the specific word specified by the explanatory message. Upon entering this token, the user can press a button 512 to submit authentication token to the server 102.

In one embodiment, a book's links are stored in a relational database and can be categorized in any of the following ways: book, electronic mail, computer log, World Wide Web site, map, document, picture, sound, video, instant messenger (IM) conversation, news article, and internal book reference. Each link can also be tied to a specific page in the book so that when a specific page is requested only the applicable links appear alongside it, as shown in FIG. 4. Clicking on the home page option to view all of the book's links presents the links in a list which can in turn be sorted by page number, link type, or date (in the case that links are tied to events taking place on specific dates and/or times). The link database may be stored in a data store, e.g., data store 120 that is closely or remotely coupled to the publisher's server 104.

The search feature 408 searches through the contents of the given book and all of the links associated with it in the relational database. Once invoked, the application 112 presents the reader with a listing of convenient hyperlinks that directly take the reader to the information desired, and that may be provided by content provider(s) 103.

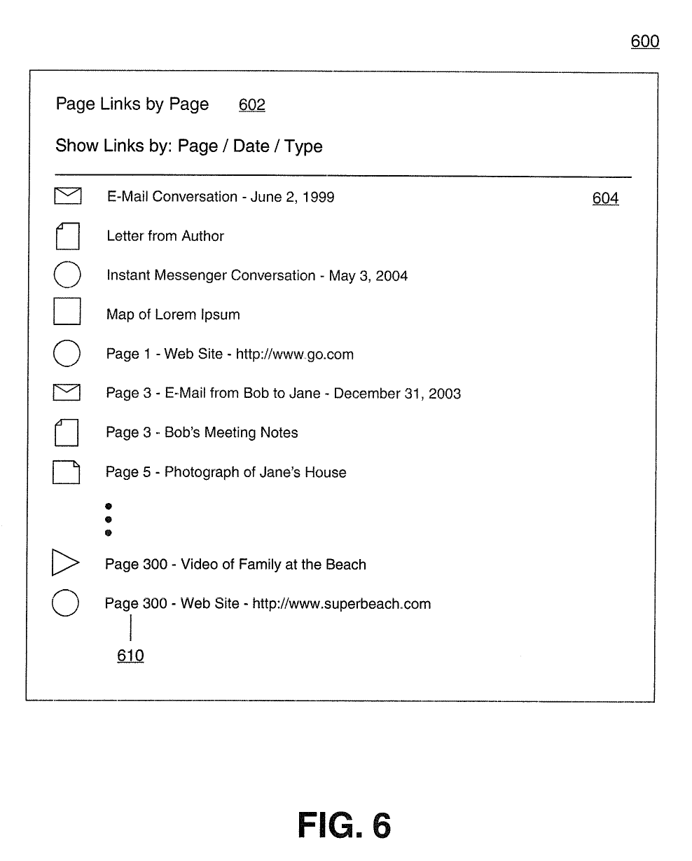

FIG. 6 is a view of an example web page that lists all of the bibliographic sources associated with a given book or other publication, under an embodiment. Page 600 includes a header section 602 that provides various link sorting options, such as by page, date, and type, as well as the present selection for the displayed links. The example of FIG. 6 illustrates the links sorted and shown by page. A link display area 604 lists all of the available links along with icons depicting link categorization. This display area provides a continuous listing of links from the first to last page of the book, with a relevant page indicator 610 for each link, and a text description of each link. Certain links, such as messages, may have relevant dates, and for these an optional date association may be provided.

Embodiments described herein are directed to a method comprising providing a printed component of a book including a page containing a reference to a network site providing access to an electronic component of the book, displaying at least a portion of the electronic component of the book upon user access to the network site, wherein the display includes a portion of the text of the book and one or more links available in that portion, and requesting authentication of the user to provide evidence of authorized use of the book.

The book typically comprises a non-fiction reference book, and the electronic component comprises a supplemental section to the printed component, and may be bibliographic information, author's notes, and source material. The network site comprises an Internet web page, and the links comprise hypertext links to one or more text files associated with the printed component.

In an embodiment, each link is associated with a graphical icon that specifies a source of the respective linked content. The source of the linked content may be a word processing document, scanned document, web page video file, audio recording, e-mail message, and photo.

Aspects of the electronic reference section system described herein may be implemented as functionality programmed into any of a variety of processing circuitry, including microprocessors, programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types.

It should also be noted that the various functions disclosed herein, including any of the processes 112 and 107 may implemented using any number of combinations of hardware, firmware, and/or as data and/or instructions embodied in various machine-readable or computer-readable media, in terms of their behavioral, register transfer, logic component, and/or other characteristics. The term “process” or “application” or “component” may refer to a software process or hardware circuit, or combination thereof that is configured or programmed to perform the described function.

Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the method and system is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the online loan application system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the system may be presented in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method to reduce the number of physical pages in a printed publication along with the associated cost of producing and distributing those pages, comprising:
providing a printed component of a book including a page containing a reference to a network site providing access to an electronic component of the book;
displaying at least a portion of the electronic component of the book upon user access to the network site, wherein the display includes a portion of the text of the book and one or more links to supplemental content available in that portion; and
accessing the supplemental content from one or more content providers upon selection of a respective link by a user.

2. The method of claim 1 wherein the book comprises a non-fiction reference book, fiction book, journal, or magazine.

3. The method of claim 2 wherein the electronic component comprises a supplemental section to the printed component, and is selected from the group consisting of: bibliographic information, author's notes, and source material.

4. The method of claim 1 wherein the network site comprises an Internet web page, and the links comprise hypertext links to one or more text files associated with the printed component and available from the one or more content providers.

5. The method of claim 4 further comprising associating each link with a graphical icon that specifies a source of the respective linked content.

6. The method of claim 5 wherein the source of the linked content is selected from the group consisting of: word processing document, scanned document, web page video file, audio recording, e-mail message, and photo.

7. The method of claim 1 wherein the portion of the electronic component of the book comprises a page of the book, the method further comprising:
displaying the page in a first display area of a graphic user interface of a client computer operated by a user, the graphical user interface including command buttons that allow page-by-page navigation through the book;
displaying the one or more links available in the page in a second display area adjacent the first display area in the graphic user interface; and
requesting authentication of the user to provide evidence of authorized use of the book.

8. The method of claim 7 further comprising:
storing the links in a relational database accessible to a publisher of the printed component;
storing the supplemental content in a data store accessible to a content provider that is separate from the publisher; and
characterizing the links according to one of: content type, content date, and page of the book in which the link is located.

9. The method of claim 8 wherein the link references a text file, and the type of link depends on an application program that produced the text file.

10. The method of claim 7 further comprising displaying user comments in a third display area in the graphic user interface.

11. The method of claim 7 wherein the step of requesting authentication of the user to provide evidence of authorized use of the book comprises:
prompting the user to enter a specific word from a specific page of the printed component; and
facilitating a purchase of the printed component if the user does not already own the printed component.

12. A system comprising:
a publisher server computer executing an electronic reference section application that provides access to an electronic component of a printed book upon user authentication of authorized use of the printed component, the publisher server having a database of books each having a printed component and an associated electronic component, wherein the publisher provides links in the printed component providing access to a network site of a content provider that provides supplemental information associated in the printed component, the supplemental information comprising the electronic component of the book;
a data store coupled to the publisher server storing the links for each book in a relational database; and
a data store maintained by the content provider to store the supplemental information.

13. The system of claim 12 further comprising a client computer coupled to the publisher computer and executing a graphical user interface program, and wherein the electronic reference section application displays at least a portion of the electronic component of the book upon user access to the content provider network site, wherein the display includes a portion of the text of the book and one or more links available in that portion.

14. The system of claim 12 wherein the network comprises the Internet, and wherein the network site comprises an Internet web page, and the links comprise hypertext links to one or more text files associated with the printed component.

15. The system of claim 12 wherein the book comprises a non-fiction reference book, and wherein the electronic component comprises a supplemental section to the printed component, and is selected from the group consisting of: bibliographic information, author's notes, and source material.

16. The system of claim 12 wherein the book comprises a fiction book, and wherein the electronic component comprises a supplemental section to the printed component including terminology or background information unique to the fiction book.

17. A method comprising:
displaying, through a graphical user interface (GUI) of a client computer, a page of an electronic version of a printed book in a first display area;
providing links to supplemental information for the page, wherein the supplemental information is provided by one or more separate content providers in electronic form over a computer network and comprises an electronic component of the printed book;
displaying the links in a second display area of the GUI; and
storing the links in a relational database in a datastore maintained by a publisher of the printed book.

18. The method of claim 17 further comprising causing the transmission of the supplemental information from the corresponding content provider to the client computer upon selection of a respective link by the user.

19. The method of claim 18 wherein the network comprises the Internet, and wherein the first and second display areas comprise an Internet web page, and the links comprise hypertext links to one or more text files provided by the content providers.

20. The method of claim 17 further comprising providing a third display area of the GUI for reader comments to the printed book or supplemental information.
